(19) United States
(12) Patent Application Publication
(10) Pub. No.: US 2026/0222214 A1
(43) Pub. Date: Jul. 30, 2026

(54) ACCELERATED FINGERPRINT UPGRADES IN CLUSTER FILE SYSTEMS USING STREAM-INFORMED LOCALITY

(71) Applicant: Dell Products L.P., Round Rock, TX (US)

(72) Inventor: Philip Shilane, Newtown, PA (US)

(21) Appl. No.: 19/040,214

(22) Filed: Jan. 29, 2025

(51) Int. Cl. H04L 9/32

(52) U.S. Cl. CPC H04L 9/3236

(57) ABSTRACT

Updating fingerprints for deduplicated data segments in a cluster network utilizing data containers by calculating new fingerprint hashes using a new hash process replacing an old hash process that generated current fingerprint hashes. A new index mapping from the present hash process to the new hash process is created, as is a new fingerprint index mapping from the updated hash process to the containers. The process generates new fingerprints with the new fingerprint hash, and calculates the new fingerprint hash values of new data segments using the new hash process. Hash index lookups are reduced by saving all of the new and old fingerprints in a container metadata structure that is loaded into a cache for lookup prior to accessing the new hash index. Any cache hit will accelerate the fingerprint lookup process.

### CROSS-REFERENCE TO RELATED APPLICATIONS

This application is related to U.S. patent application Ser. No. 18/972,003 filed on Dec. 6, 2024 and entitled “Fingerprint Upgrade Process for Cluster File Systems,” and U.S. patent application Ser. No. ______ filed on Jan. 29, 2025 and entitled “Supporting Write Operations During a Fingerprint Upgrade Process in Cluster File Systems,” both of which are assigned to the assignee of the present application, and which is hereby incorporated by reference in its entirety.

### TECHNICAL FIELD

Embodiments are directed to distributed networks, and more specifically to automatically upgrading data segment fingerprints for deduplicated backup systems.

### BACKGROUND

A distributed (or cluster) network runs a filesystem in which data is spread across multiple storage devices as may be provided in a cluster of nodes. Cluster networks represent a scale-out solution to single node systems by providing networked computers that work together so that they essentially form a single system. The filesystem is shared by being simultaneously mounted on multiple servers so that a distributed filesystem can present a global namespace to clients (nodes) so that files appear to be in the same central location. The Santorini filesystem represents a type of cluster system that stores the file system metadata on a distributed key value store and the file data on object store. The file/namespace metadata can be accessed by any front end node, and any file can be opened for read/write operations by any front-end node.

One major application implemented on a cluster network is a deduplicated backup system that eliminates redundant copies of data to reduce storage requirements. Data compression methods are used to store only one unique instance of data by replacing redundant data blocks with pointers to the unique data copy. As new data is written to a system, duplicate chunks are replaced with these pointer references to previously stored data. The Data Domain File System (DDFS) is an example of an inline data deduplication filesystem. As data gets written to the filesystem, DDFS breaks it into variable sized segments and a group of segments are packed in a compression region, and a fingerprint signature (hash value) is calculated for segments of compression regions and serves as a pointer reference to the original data. Many current systems utilize hash functions in accordance with the SHA-1 (Secure Hash Algorithm 1) standard, which takes an input and produces a 160-bit hash value.

As cluster networks are maintained into the future, present fingerprinting techniques are increasingly vulnerable to compromise through cyber-attacks. Consequently, it is highly likely that hashing algorithms for fingerprinting will evolve and change in response by government and corporate initiatives to maintain data security. In fact, SHA-1 has already been replaced by SHA-2 for data transfers under federal requirements, and other algorithms such as SHA-3 and SHA-256 are being incorporated as well.

What is needed, therefore, is a way to automatically upgrade hashing methods for fingerprint calculations to accommodate ever developing hashing algorithms. What is further needed is a way to reduce the number of hash index lookups to accelerate the fingerprint lookup process.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dell and EMC are trademarks of Dell Technologies, Inc.

### BRIEF DESCRIPTION OF THE DRAWINGS

In the following drawings like reference numerals designate like structural elements. Although the figures depict various examples, the one or more embodiments and implementations described herein are not limited to the examples depicted in the figures.

FIG. 1 is a block diagram illustrating a deduplicated backup system in a cluster network implementing an automatic fingerprint upgrade process, under some embodiments.

FIG. 2 illustrates files an example Merkle tree representation of files in a deduplication backup system, under some embodiments.

FIG. 3 illustrates a Data Domain filesystem Merkle tree accessed by a file under an example embodiment.

FIG. 4 illustrates an example container layout for use in a fingerprint upgrade process for deduplicated backup systems in cluster networks, under some embodiments.

FIG. 5A illustrates a simplified fingerprint index under an example embodiment.

FIG. 5B illustrates a bucketized version of a fingerprint index, under an example embodiment.

FIG. 6 illustrates an impact on system performance during an fingerprint update process, under some embodiments.

FIG. 7 is a flowchart that illustrates a fingerprint updating process for cluster networks, under some embodiments.

FIG. 8 graphically illustrates the updating of fingerprints from an old hash algorithm to a new algorithm, under an example embodiment.

FIG. 9 illustrates the updating of fingerprints from an old hash algorithm to a new algorithm using a cache to accelerate fingerprint lookups, under an example embodiment.

FIG. 10 is a flowchart that illustrates a method of updating of fingerprints from an old hash algorithm to a new algorithm using a cache to accelerate fingerprint lookups, under an example embodiment.

FIG. 11 is a block diagram of a computer system used to execute one or more software components of the processes described herein, under some embodiments.

### DETAILED DESCRIPTION

A detailed description of one or more embodiments is provided below along with accompanying figures that illustrate the principles of the described embodiments. While aspects of the invention are described in conjunction with such embodiments, it should be understood that it is not limited to any one embodiment. On the contrary, the scope is limited only by the claims and the invention encompasses numerous alternatives, modifications, and equivalents. For the purpose of example, numerous specific details are set forth in the following description in order to provide a thorough understanding of the described embodiments, which may be practiced according to the claims without some or all of these specific details. For the purpose of clarity, technical material that is known in the technical fields related to the embodiments has not been described in detail so that the described embodiments are not unnecessarily obscured.

It should be appreciated that the described embodiments can be implemented in numerous ways, including as a process, an apparatus, a system, a device, a method, or a computer-readable medium such as a computer-readable storage medium containing computer-readable instructions or computer program code, or as a computer program product, comprising a computer-usable medium having a computer-readable program code embodied therein. In the context of this disclosure, a computer-usable medium or computer-readable medium may be any physical medium that can contain or store the program for use by or in connection with the instruction execution system, apparatus or device. For example, the computer-readable storage medium or computer-usable medium may be, but is not limited to, a random-access memory (RAM), read-only memory (ROM), or a persistent store, such as a mass storage device, hard drives, CDROM, DVDROM, tape, erasable programmable read-only memory (EPROM or flash memory), or any magnetic, electromagnetic, optical, or electrical means or system, apparatus or device for storing information.

Alternatively, or additionally, the computer-readable storage medium or computer-usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory. Applications, software programs or computer-readable instructions may be referred to as components or modules. Applications may be hardwired or hard coded in hardware or take the form of software executing on a general-purpose computer or be hardwired or hard coded in hardware such that when the software is loaded into and/or executed by the computer, the computer becomes an apparatus for practicing the invention. In this specification, these implementations, or any other form that the invention may take, may be referred to as techniques. In general, the order of the steps of disclosed processes may be altered within the scope of the described embodiments.

Embodiments are directed to systems and methods for automatically updating data segment fingerprint hash algorithms for deduplicated backups in cluster network filesystems.

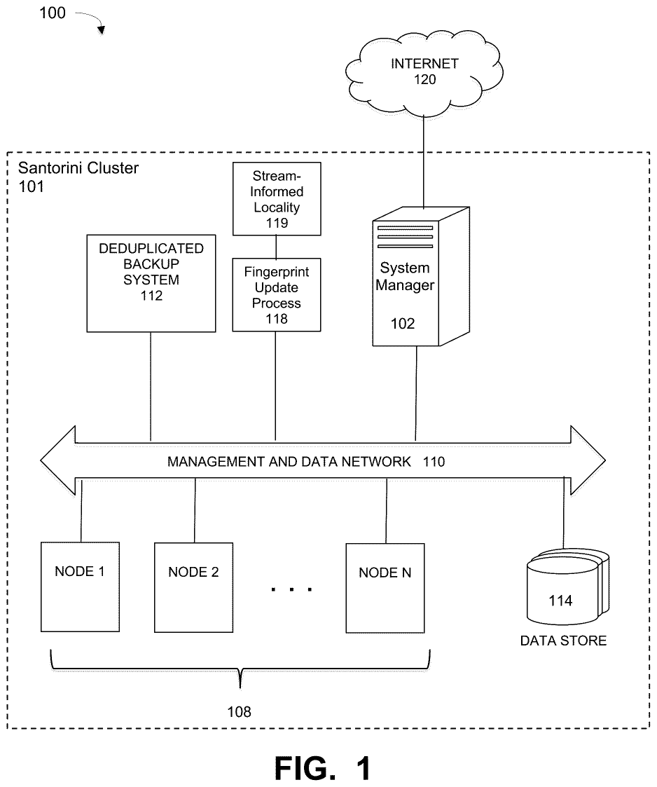

FIG. 1 is a block diagram illustrating a deduplicated backup system in a cluster network implementing an automatic fingerprint upgrade process, under some embodiments. System 100 comprises a large-scale network that includes a cluster network 101 having a number of different devices, such as server or client computers 102, nodes 108, storage devices 114, and other similar devices or computing resources. Other networks may be included in system 100 including local area network (LAN) or cloud networks, and virtual machine (VM) storage or VM clusters. These devices and network resources may be connected to a central network, such as a data and management network 110 that itself may contain a number of different computing resources (e.g., computers, interface devices, and so on). FIG. 1 is intended to be an example of a representative system implementing a distributed computing system under some embodiments, and many other topographies and combinations of network elements are also possible.

A distributed system 101 (also referred to as a cluster or clustered system) typically consists of various components (and processes) that run in different computer systems (also called nodes) that are connected to each other. These components communicate with each other over the network via messages and based on the message content, they perform certain acts like reading data from the disk into memory, writing data stored in memory to the disk, perform some computation (CPU), sending another network message to the same or a different set of components and so on. These acts, also called component actions, when executed in time order (by the associated component) in a distributed system would constitute a distributed operation.

A distributed system may comprise any practical number of compute nodes 108. For system 100, n nodes 108 denoted Node 1 to Node N are coupled to each other and a connection manager 102 through network 110. The connection manager can control automatic failover for high-availability clusters, monitor client connections and direct requests to appropriate servers, act as a proxy, prioritize connections, and other similar tasks.

In an embodiment, cluster network 101 may be implemented as a Santorini cluster that supports applications such as a data backup management application that coordinates or manages the backup of data from one or more data sources, such as other servers/clients to storage devices, such as network storage 114 and/or virtual storage devices, or other data centers. The data generated or sourced by system 100 may be stored in any number of persistent storage locations and devices, such as local client or server storage. The storage devices represent protection storage devices that serve to protect the system data through applications 104, such as a backup process that facilitates the backup of this data to the storage devices of the network, such as network storage 114, which may at least be partially implemented through storage device arrays, such as RAID (redundant array of independent disks) components. The data backup system may comprise a Data Domain system, in which case the Santorini network 101 supports various related filesystem and data managers, such as PPDM, as well as services such as ObjectScale and other services.

In an embodiment network 100 may be implemented to provide support for various storage architectures such as storage area network (SAN), Network-attached Storage (NAS), or Direct-attached Storage (DAS) that make use of large-scale network accessible storage devices 114, such as large capacity disk (optical or magnetic) arrays for use by a backup server, such as a server that may be running Networker or Avamar data protection software backing up to Data Domain protection storage, such as provided by Dell Technologies, Inc.

Cluster network 101 includes a network 110 and also provides connectivity to other systems and components, such Internet 120 connectivity. The networks may be implemented using protocols such as Transmission Control Protocol (TCP) and/or Internet Protocol (IP), well known in the relevant arts. In a cloud computing environment, the applications, servers and data are maintained and provided through a centralized cloud computing platform.

In an embodiment, system 100 uses Kubernetes as an orchestration framework for clustering the nodes 1 to N in FIG. 1. Containerization is an OS-level virtualization method for deploying and running distributed applications without launching an entire VM for each application. Instead, multiple isolated systems are run on a single control host and access a single kernel. The application containers hold the components such as files, environment variables and libraries necessary to run the desired software to place less strain on the overall resources available. Containerization technology involves encapsulating an application in a container with its own operating environment, and the well-established Docker program deploys containers as portable, self-sufficient structures. In Kubernetes, a pod is the smallest deployable data unit that can be created and managed and constitutes a group of one or more containers, with shared storage and resource requirements.

As shown in FIG. 1, network 101 includes a deduplicated backup system 112. This may be implemented by a specialized node in system 100. Alternatively, it may be executed as a server process, such as by server 102 or any other server or client computer in the system. Such a system can be used to implement a Data Domain (deduplication backup) process that uses object storage (e.g., Dell ObjectScale), Kubernetes, and different types of storage media, such as HDD, Flash memory, SSD memory, and so on. In an embodiment, a PowerProtect Data Manager (PPDM) microservices layer builds on the Data Domain system to provide data protection capabilities for VM image backups and Kubernetes workloads. Santorini exposes a global namespace that is a union of all namespaces in all domains. Distributed key value (KV) stores are also a component of Santorini and are used to hold much of the metadata such as the namespace Btree, the Lp tree, fingerprint index, and container fingerprints.

The Data Domain File System (DDFS) from DellEMC is an example deduplication filesystem in which the filesystem anchors and segments data as it is ingested. The filesystem keeps track of segments which are stored on the disk, and if the segments are accessed again, the filesystem just stores a reference to the original data segment that was written to disk. A file is therefore a stream of segments, and these segments are uniquely identified by a key/label data element, called a fingerprint. Given a file offset and length, the corresponding data segment fingerprints need to be looked up to access the actual data.

Embodiments are generally described with respect to Data Domain File System (DDFS) backup environments, however, embodiments are not so limited and any other type of deduplication (or deduplicated) filesystems may also be used. The Data Domain File System (DDFS) is an example of an inline data deduplication filesystem. As data gets written to the filesystem, DDFS breaks it into variable sized segments and a group of segments are packed in a compression region. A number of compression regions are grouped together and written as a container to disk. DDFS calculates fingerprint signatures for each segment using the SHA1 algorithm. DDFS has an on-disk fingerprint index table, which maps the fingerprint to the container-ID, that has the corresponding segment data. The container has a metadata section followed by several data sections. The data sections store the compression regions; and the container metadata section stores the meta information of the container, i.e., it stores the total number of compression regions, the total number of segments, the fingerprint of each segment, and so on.

In a deduplicated filesystem that forms segments from data, these segments are uniquely identified by their key/label called as fingerprint. Given a file offset and length, the corresponding data segment fingerprints need to be looked up. To provide faster offset to fingerprint lookup the mapping is stored in a Merkle tree format where the leaf nodes represent data segments and their fingerprints are stored in the parent nodes which are metadata segments. In a Merkle tree, every non-leaf node is labeled with the hash of the labels of its children nodes to allow efficient and secure verification of the contents of large data structures.

A file in DDFS is represented by a Merkle tree with user data as variable sized segments at the bottom level of the tree, referred to as L0 segments. The SHA1 fingerprints of those segments are grouped together at the next higher level of the tree to form new segments, referred to as L1 segments. SHA1 fingerprints of L1 segments are grouped together as L2 segments, and this continues up to L6 which represents the entire file. The top segment of the tree is always an L6 segment, even though it may refer to any lower numbered segments. Segments above L0 are referred to as Lp chunks. The L6 segment of every file is stored in a namespace which is represented as a B+ Tree. The L0 and Lp segments are written to separate containers, known as L0 and Lp containers.

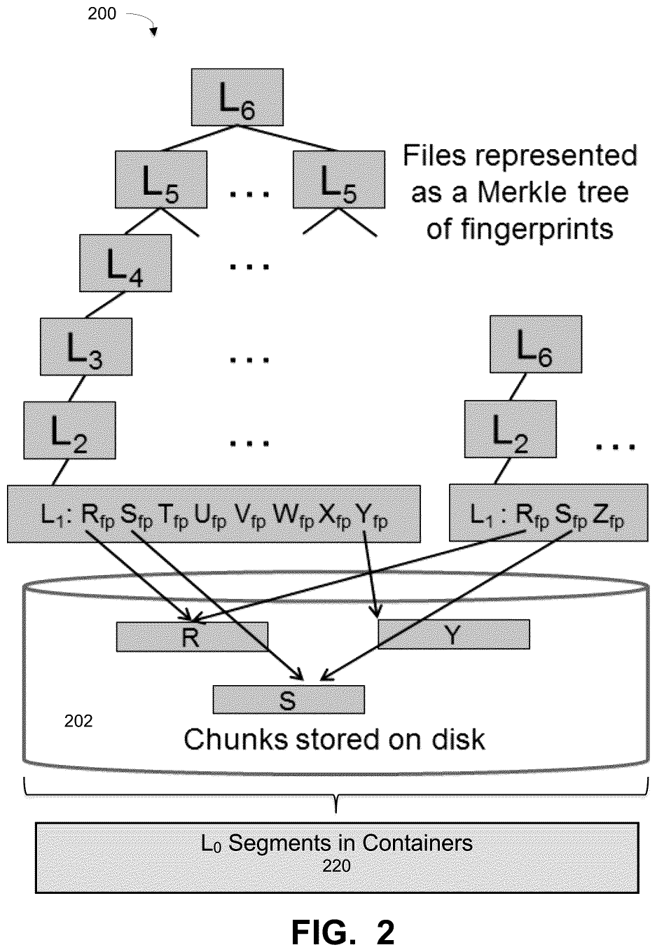

FIG. 2 illustrates files an example Merkle tree representation of files in a deduplication backup system, under some embodiments. As shown in FIG. 2, Merkle tree 200 comprises layers L0 to L6. The chunks directly written to disk 202 are referred to as L₀, meaning the lowest level of the tree. This data as stored on the disk represents the L0 segments in the containers 220.

Consecutive L0 chunks are referenced with an array of fingerprints by an L₁ chunk, which itself is identified by a fingerprint. An array of L₁ fingerprints is referenced by an L₂ chunk, continuing to the root of the tree; the root is always labeled L₆ for convenience, even if the file is small enough not to need intermediate nodes such as the example on the right side of the figure. The L₁-L₆ chunks are referred to as Lₚ chunks, where p is a parameter that ranges from 1 to 6 and indicates metadata representing the file. Deduplication takes place because a chunk can be referenced multiple times. The file system is a forest of Merkle trees, but these trees are not disjoint, particularly at the lowest level. In general, Lₚ chunks are themselves stored on disk in containers, which include a relatively small (hundreds of KB) metadata section with a list of fingerprints for the chunks within the container. Thus, they may be read more quickly than the full container.

A Data Domain or similar system can efficiently copy an existing file using the same underlying Merkle tree. It creates the new file with a new name, and therefore a new L₆ root of the tree, but that tree then references the identical L_{P} chunks. As this operation involves only the root of the tree, it is trivially fast and does not increase physical space in use beyond the one chunk containing the L₆.

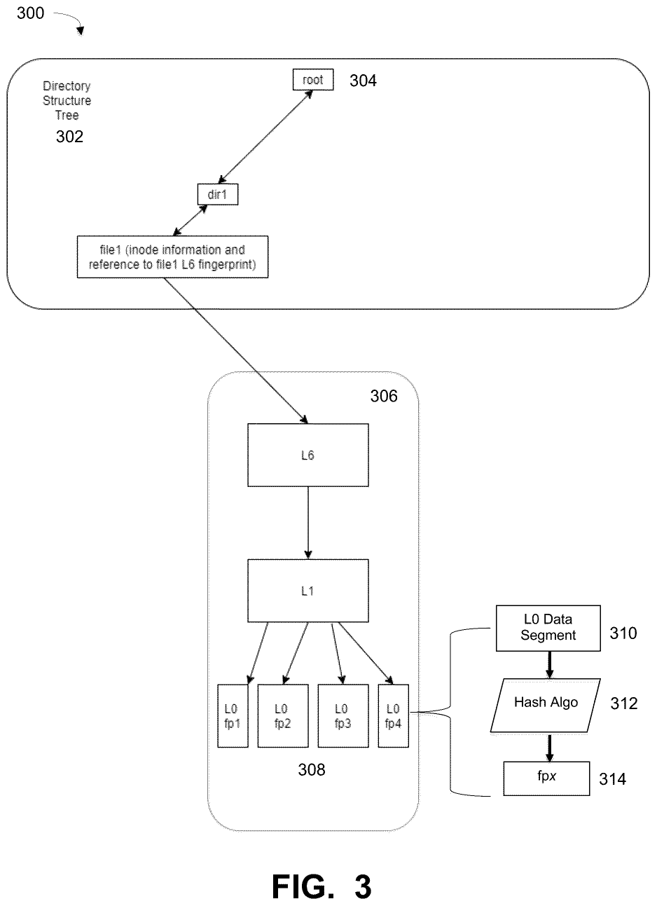

FIG. 3 illustrates a DDFS Merkle tree accessed by a file under an example embodiment. As shown in system 300, a directory structure tree 302 comprises a root directory 304, which accesses a directory (dir1) that holds a particular file (file1). The directory tree data for file1 comprises inode information and a reference to the file1 L6 fingerprint in the associated Merkle tree 306.

As mentioned above, the data chunks directly written to disk are referred to as L₀, meaning the lowest level of the tree and which hold the respective fingerprints (fp1 to fpn). Consecutive L₀ chunks 308 are referenced with an array of fingerprints by an L₁ chunk, which itself is identified by a fingerprint. An array of L₁ fingerprints is referenced by an L₂ chunk, continuing to the root of the tree; the root is always labeled L₆ for convenience, even if the file is small enough to not need intermediate nodes. The L₁-L₆ chunks are referred to as Lp chunks, where p is a parameter that ranges from 1 to 6 and indicates metadata representing the file. Deduplication takes place because a chunk can be referenced multiple times.

For the embodiments described above, as data is written into a deduplicated storage system, it is divided into segments (fixed or variable sized) and represented by a fingerprint (fpx). The fingerprint consists of a SHA-1 hash over the segment and possibly other fields such as a segment size, XOR over the bytes, etc. In general, the terms a “SHA-1 fingerprint” or “SHA-2 fingerprint” mean that the hash used in the fingerprint is generated using the SHA-1 or SHA-2 algorithm without specifying what other fields are part of the fingerprint. The fingerprint is a unique identifier for deduplication purposes and is used to identify segments needed to reconstruct a file during a file read (i.e., data recovery).

FIG. 3 illustrates a process of generating the fingerprints (fp) by inputting the L0 data segments 310 into the hash algorithm (e.g., SHA-1) 312 that then produces a hash of the data segment value to produce a corresponding fingerprint fpx, 314.

In general, the hash is calculated immediately after a segment is formed and is used for verifying segment validity later. By recalculating the hash of the data and comparing it to the previously stored hash, a data corruption can be detected if the hashes differ. The hash may be calculated using a software algorithm, or it may be calculated using specialized CPU instructions provided by a CPU manufacturer. The hash algorithm needs to be a standardized and secure algorithm so that software running on different systems will produce the same hash given the same input.

In an embodiment, the deduplicated storage system has three main data structures that depend heavily on fingerprints. These are the container metadata, fingerprint index, and Lp tree (or file recipe).

With respect to the container metadata, after performing deduplication on incoming segments, all remaining segments are stored to persistent storage. They are grouped into buffers, compressed, and packed into a fixed-sized container. The container size depends on properties of the underlying storage layer and may be aligned to a RAID stripe size or other consistent size used for efficient I/O. As an example, the containers in a Santorini system are of 16 MB size to align with the ObjectScale chunk size used for erasure coding. Other similar sizes are also possible, however.

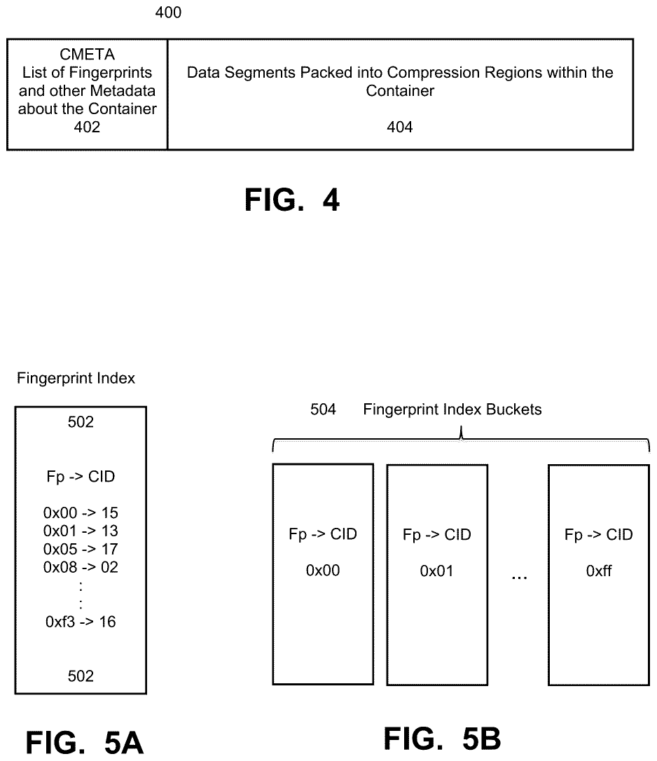

FIG. 4 illustrates an example container layout for use in a fingerprint upgrade process for deduplicated backup systems in cluster networks, under some embodiments. Data element 400 of FIG. 4 represents a container that comprises a section 404 allocated for compressed data segments, along with a metadata section 402 holding fingerprints and other metadata about the segments in the container. This is referred to as container metadata (CMETA), and it may be stored as part of the container 400, as shown in FIG. 4, or separately from the container, or the CMETA could be stored both with the container and separately for efficient lookups from faster media.

When the fingerprinting hash algorithm is updated, such from SHA-1 to SHA-2, the container metadata needs to be rewritten with new SHA-2 fingerprints. In designs where the CMETA 402 is part of a container 400, the container itself will need to be rewritten. This effect can potentially overflow into multiple containers, and thus present a significant operation.

Another data structure implicating fingerprints is the fingerprint index, which records where segments are stored in the system. A fingerprint index basically provides a mapping from fingerprints to a container or containers. Other data structures then map from the container to a physical location in storage.

There are multiple ways to implement a fingerprint index. FIG. 5A illustrates a simplified fingerprint index under an example embodiment. The simplified fingerprint index 502 shows a mapping from fingerprint to container ID (CID). The fingerprint comprises a hexadecimal number (e.g., 0x01) and container ID (CID) is shown as a decimal value (e.g., 13). However, this may actually be a more complex record with container ID, compression region offset, compression region size, etc. During deduplication and file reads, the fingerprint index is checked to identify whether the fingerprint and its associated segment have been stored, and where the segment is stored. There should be a one-to-one mapping between fingerprints in the container metadata 402 and the fingerprint index 502.

The other common way to implement a fingerprint index is as a set of buckets. FIG. 5B illustrates a bucketized version of a fingerprint index, under an example embodiment. In this embodiment, the fingerprint index is stored as a set of buckets 504, where a subset of the fingerprint index records are stored within each bucket. A few bytes from the fingerprint are used to identify which bucket to load and check. FIGS. 5A and 5B illustrate only two example variations of the fingerprint index, and there may be other variants of the fingerprint index such as a short-fingerprint version that is loaded in faster access storage as an optimization.

Updating fingerprints for a new hash algorithm (e.g., SHA-1 to SHA-2) requires the fingerprint index and related structures to be rewritten.

As stated above, the third main data structure implicating fingerprints is the file recipe or Lp Tree. A file is commonly represented in Santorini (and similar cluster systems) by a sequence of fingerprints referencing its segments, where the filesystem creates a tree structure on this sequence of fingerprints to accelerate random I/O operations. As shown in FIGS. 2 and 3, data segments are referred to as L0 segments since they are the bottom of a metadata tree representing the file. Fingerprints to those L0 segments are grouped in order and stored in L1 segments. Fingerprints referencing L1 segments are similarly grouped in order and stored in L2 segments. The overall Lp tree (e.g., 200 or 306) represents the file recipe, where the files are represented as a Merkle tree of fingerprints.

In this case, updating fingerprints for a new hash algorithm (e.g., SHA-1 to SHA-2) requires that all Lp trees will be rewritten with the updated fingerprints.

In practical cluster networks, when updating the hash function for fingerprinting for any of the above described (or other) data elements, there are several overall constraints that must be considered, such as data availability, space limitations, and resource overhead.

As a first requirement, then, the upgrade must maintain file availability after the hash algorithm update without any loss of customer data. Depending on customer requirements, it may be acceptable to take the system offline for this major upgrade of the system. Alternatively, it may be sufficient and necessary to maintain data availability for just the reads during the upgrade. In other cases, it may be necessary to maintain data availability for both concurrent reads and writes during the fingerprint update.

As mentioned, the second consideration is space related. A hash algorithm update will almost always require more space both temporarily and during eventual deployment given increased code size, data elements, and so on. For example, switching from a SHA-1 (20 bytes) to a SHA-2 (32 bytes) algorithm requires larger CMETA, fingerprint index, and Lp trees in the long term. Although the data segments 404 are usually seen as constituting the majority of container storage space, metadata can be a significant fraction, particularly in high deduplication scenarios. Furthermore, in the short term period of the update, there may be both present and early (e.g., SHA1 and SHA2) versions of at least some data structures during the update process, and these overheads should be minimized. Estimating how much space is needed both in the long term and short term must be considered before starting an update.

The third consideration for the hash algorithm update is the resource overhead needed to complete the update. For example, if reads and writes to the system need to be disabled during upgrade, it would be required to minimize this downtime. Even if the system can perform reads and writes while updating the fingerprint hash, there will likely be computational and I/O overheads while updating data structures, and this can potentially impact system performance significantly.

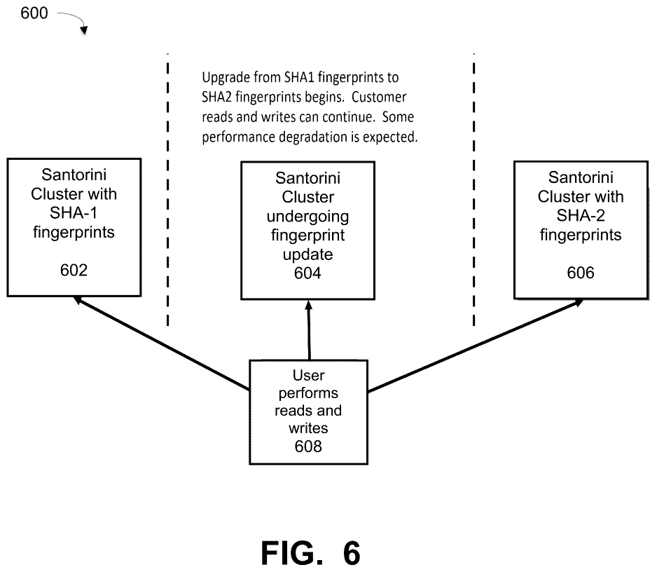

FIG. 6 illustrates an impact on system performance during an fingerprint update process, under some embodiments. Diagram 600 of FIG. 6 illustrates different states of the cluster network while it undergoes an update (or upgrade) of the fingerprint hash algorithm from SHA-1 to SHA-2, for example. State 602 illustrates the cluster network using SHA-1 based fingerprints and state 606 illustrates the cluster network using new SHA-2 based fingerprints. In between these two states is the update process as the cluster network undergoes the fingerprint update, 604. During this process, the user may perform read and write operations on the cluster network, 608. As mentioned above, the update process uses and imposes certain constraints on the system, thus during the update state 604 from SHA-1 to SHA-2, the user read and write operations may continue, but some performance degradation is likely to occur, as well as other effects, such as increased space usage, and so on.

Embodiments include a fingerprint update process that performs a hash algorithm update attempts to minimize system impact. This may be provided by a fingerprint update processing component 118 as shown in system 100 of FIG. 1, and that may be embodied as a component in the cluster network 101, or as a process executed by the deduplicated backup system 112, or as an external process.

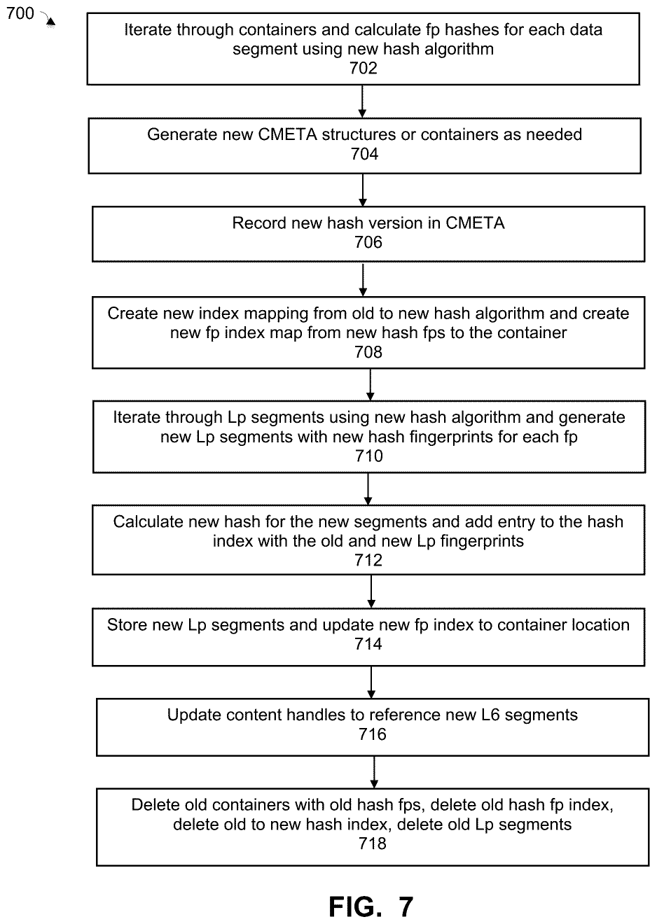

FIG. 7 is a flowchart that illustrates a fingerprint updating process for cluster networks, under some embodiments. The example of FIG. 7 describes an update from SHA-1 to SHA-2 as the hash algorithm for the fingerprints, though it should be noted that any current and next hash algorithm can be used, such as from SHA-2 to SHA-3 or SHA-256, and so on.

Process 700 starts by iterating through the containers and calculates new SHA2 hashes for each segment. Since it is not best practice to update containers in-place, and more space is likely needed for a larger hash, new containers (or CMETA structures at least) are generated by this process, 704. The hash version of the new hash algorithm is recorded in the version information section of the CMETA structure, 706. While creating SHA-2 hashes, the system creates a new index mapping from the SHA-1 hash to the SHA-2 hash, and creates a new fingerprint index mapping from the SHA-2 fingerprints to the container, 708.

The new index that maps from SHA2 fingerprints to containers is identical to those shown in FIGS. 5A and 5B, though with SHA2 fingerprints instead of SHA1 fingerprints. The SHA1-to-SHA2 hash mapping is generated as the containers are converted. When processing segments in a container, the known SHA1 hashes are used to calculate the new SHA2 hashes. A new index from SHA1-to-SHA2 is created with this information. This index is used when upgrading the Lp segments because they consist of sequences of SHA1 fingerprints without the content easily accessible. The SHA1-to-SHA2 index is thus used to create the new Lp segments with SHA2 fingerprints. The SHA1-to-SHA2 index can be removed when upgrade is complete.

With reference back to FIG. 7, the process 700 iterates through the Lp segments from L1 up towards L6. Each Lp segment has an array of fingerprints referencing the lower-level segments. For each fingerprint, the system looks it up in the SHA-1 to SHA-2 index, and generates a new Lp segment with SHA2 fingerprints, 710.

In step 712, the system calculates a SHA-2 hash for the new Lp segment and adds an entry to the SHA-1 to SHA-2 index with the old and new Lp fingerprint. It then stores the new Lp segment and update the SHA2 fingerprint index to the container location, 714. If the Lp segment is stored in a key-value store or other structure, those structures are also updated accordingly.

The process then continues steps 710 to 714 as it iterates up towards the L6 segments.

After the iterations over the containers (702) and Lp segments (710), the system updates the content handles to reference the new L6 segments, 716. It then deletes: the old containers (or CMETAs) with SHA1 hashes, the SHA1 fingerprint index, and the SHA-1 to SHA-2 index, as well as the old Lp segments if they are not already deleted from containers, 718. Users can continue to read files while the upgrade progresses since the old containers and Lp segments are deleted at the end.

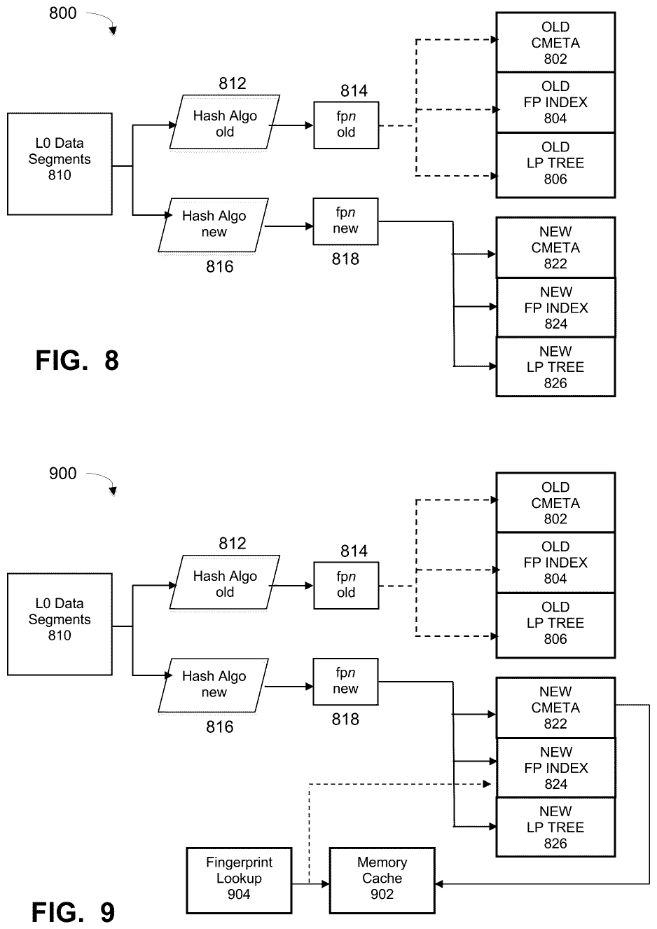

FIG. 8 graphically illustrates the updating of fingerprints from an old hash algorithm to a new algorithm, under an example embodiment. As shown in diagram 800, sets of L0 data segments 802 are first hashed using a present (or old) hash algorithm 812 to produce old fingerprints 814. These fingerprints are then initially used for certain relevant data elements, such as container metadata 802, fingerprint index 804 and Lp tree 806. Upon an upgrade to use a new hash algorithm 816, the data segments 810 are hashed again using this algorithm to produce new fingerprints 818. These fingerprints then replace the old fingerprints 814 in the new data elements 822, 824, 826 to replace the old data elements 802, 804, and 806. This process is iterated over all of the Lp segments for all of the containers, as shown in process 700.

Depending on the system configuration and capabilities, certain optimizations can be provided. For example, within each of the main iteration steps, parallel operations can be performed to accelerate the fingerprint update. For example, multiple containers or CMETAs can be updated in parallel. Similarly, multiple Lp segments can be updated simultaneously, as can content handles.

It is important to note that for this embodiment, the SHA-1 fingerprints must be safe to use to represent the old data structures during the update process. If not, it would not be possible to read back the user files.

In general, this embodiment also imposes some degree of space usage. For example, depending on system configuration, the update process may double the container space used, and utilize multiple fingerprint indexes simultaneously until update is complete. Furthermore, the Lp segment conversion may require a high number of SHA-1 to SHA-2 index lookups (which are each random I/Os), and this number increases with the logical size of the dataset. Process 700 represents a relatively straightforward and easily implemented fingerprint update solution, but may not be suitable for constrained systems. Instead, it is generally more suitable for cloud implementations or systems that use more object storage and block storage space.

As mentioned above, any current and future hash algorithm may be used for the fingerprint update process. Examples discuss the use of SHA-1 and SHA-2, but new hash algorithms are constantly being developed. One such new algorithm is the SHA-256 hashing algorithm that has been implemented in certain data reduction hardware to find duplicate data, and which is then stored as a single instance for multiple sources to share. This provides enhanced data efficiency while maintaining a long history of data integrity. The SHA-256 algorithm generates a 32-byte code for each 32 KB block of data. As an example, consider a system with 1 PB of written data with 5% updated per day. In 1 million years of operation, there is a 20% likelihood of a hash collision. As each 128 KB track is handled as 4 blocks of 32 KB there would need to be a hash collision on all four blocks in the same 128 KB track to have an actual hash collision. The odds of having all 4 collide makes this only theoretical (less than a 1% chance in a trillion years of operation). This illustrates but one example of the benefits of updating hash algorithms to the best version currently available as data protection and storage needs evolve.

### Reducing Fingerprint Lookups

In an embodiment, process 700 of FIG. 7 is optimized by reducing the number of SHA1-to-SHA2 index lookups. In process 700, the number of lookups generally increases proportionally with the logical capacity of the system, and all of the lookups are random since there is no ordering to the fingerprints in Lp segments.

Embodiments of system 100 of FIG. 1 include a processing component 119 that leverages stream-informed locality to accelerate fingerprint conversion in an analogous manner that it is currently used to accelerate deduplication. This embodiment includes a memory cache that stores the appropriate CMETA so that other fingerprints needed in subsequent conversions can be accessed much more quickly if they are available.

FIG. 9 illustrates the updating of fingerprints from an old hash algorithm to a new algorithm using a cache to accelerate fingerprint lookups, under an example embodiment. Diagram 900 of FIG. 9 proceeds substantially similarly to the process flow of diagram 800 in FIG. 800 where sets of L0 data segments 802 are first hashed using a present (or old) hash algorithm 812 to produce old fingerprints 814, also hashed using a new hash algorithm to produce new fingerprints 818 that are stored in a new CMETA 822. This CMETA is then stored in a memory cache, which can be checked by a fingerprint lookup process 904. If the fingerprint is present in the cache, it can be returned immediately, otherwise if there is a cache miss, the fingerprint can be retrieved from the new fingerprint index 824.

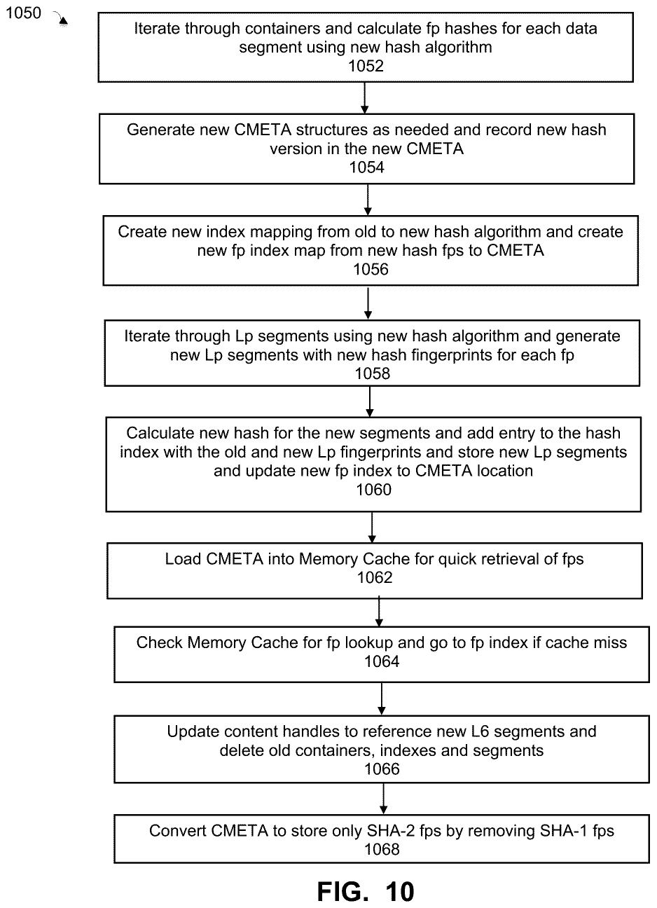

FIG. 10 is a flowchart that illustrates a method of updating of fingerprints from an old hash algorithm to a new algorithm using a cache to accelerate fingerprint lookups, under an example embodiment. The initial steps of process 1050 correspond to those of process 700 shown in FIG. 7. That is, the starts by iterating through the containers and calculates new SHA2 hashes for each segment, 1052, with new CMETA structures generated by this process, with the hash version of the new hash algorithm is recorded in the version information section of the new CMETA structure, 1054. The system creates a new index mapping from the SHA-1 hash to the SHA-2 hash, and creates a new fingerprint index mapping from the SHA-2 fingerprints to the container, 1056. The process updates the SHA1-to-SHA2 index to include the container ID (or CMETA identifier) for the segment corresponding to the SHA2 fingerprint and inserts this information when adding records to the new fingerprint index. It will also adjust the CMETA structure to hold both the SHA1 and its corresponding SHA2 fingerprint for all of the fingerprints in the container.

The process then iterates through the Lp segments from L1 up towards L6, and for each fingerprint, the system looks it up in the SHA-1 to SHA-2 index, and generates a new Lp segment with SHA2 fingerprints, 1058 (which corresponds to step 710 in FIG. 7). In step 1060, the system calculates a SHA-2 hash for the new Lp segment and adds an entry to the SHA-1 to the SHA-2 index with the old and new Lp fingerprint, and stores the new Lp segment and updates the SHA2 fingerprint index to the CMETA location.

When looking up in the SHA1-to-SHA2 index, the system uses the container ID to load the appropriate CMETA into a memory cache 902 so that other fingerprints that are likely to needed in the near future (e.g., by a fingerprint lookup process 904) can be accessed from the memory cache, step 1062. This allows the system to directly map from SHA1 to SHA2 using cached CMETA records, and for quick retrieval of fingerprints without checking the on-disk fingerprint index first, and if there is a miss in the cache, the lookup operations simply checks the index as usual, 1064. This process is analogous to an SSD short-fingerprint cache to accelerate index lookups.

As in process 700, in step 1066 of FIG. 10, the process 1050 updates the content handles to reference the new L6 segments and then deletes the old containers, indexes, and segments (as shown in step 718 of FIG. 7). New for process 1050 is step 1068 in which the system converts the CMETA structures to only store SHA2 fingerprints and removes the SHA1 fingerprints, 1082. This last step could be deferred to part of a normal garbage collection algorithm and performed lazily.

The use of a cache to store the latest fingerprint information for lookup exploits any stream-informed locality of the fingerprints by the prompt caching of newly generated fingerprint data. This can then be used through the caching mechanism to speed at least some fingerprint lookup operations. The process of FIG. 10 may require some use of multiple indexes, but generally reduces the random I/Os needed, as compared to non-cached embodiments, and is compatible with other optimizations to reduce space overheads. Reads can be supported in the same manner as described above with respect to FIGS. 7 and 8.

As described above, in an embodiment, system 100 includes certain processes that may be implemented as a computer implemented software process, or as a hardware component, or both. As such, it may include executable modules executed by the one or more computers in the network, or embodied as a hardware component or circuit provided in the system. The network environment of FIG. 1 may comprise any number of individual client-server networks coupled over the Internet or similar large-scale network or portion thereof. Each node in the network(s) comprises a computing device capable of executing software code to perform the processing steps described herein.

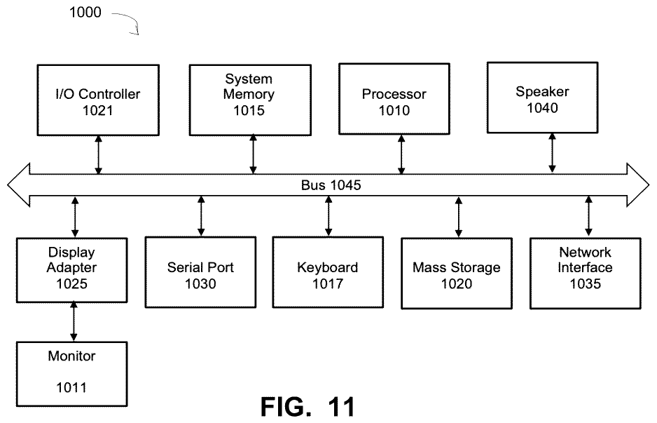

FIG. 11 is a block diagram of a computer system used to execute one or more software components of the processes described herein, under some embodiments. The computer system 1000 includes a monitor 1011, keyboard 1017, and mass storage devices 1020. Computer system 1000 further includes subsystems such as central processor 1010, system memory 1015, input/output (I/O) controller 1021, display adapter 1025, serial or universal serial bus (USB) port 1030, network interface 1035, and speaker 1040. The system may also be used with computer systems with additional or fewer subsystems. For example, a computer system could include more than one processor 1010 (i.e., a multiprocessor system) or a system may include a cache memory.

Arrows such as 1045 represent the system bus architecture of computer system 1000. However, these arrows are illustrative of any interconnection scheme serving to link the subsystems. For example, speaker 1040 could be connected to the other subsystems through a port or have an internal direct connection to central processor 1010. The processor may include multiple processors or a multicore processor, which may permit parallel processing of information. Computer system 1000 is an example of a computer system suitable for use with the present system. Other configurations of subsystems suitable for use with the present invention will be readily apparent to one of ordinary skill in the art.

Computer software products may be written in any of various suitable programming languages. The computer software product may be an independent application with data input and data display modules, or instantiated as distributed objects. The computer software products may also be component software. An operating system for the system may be one of the Microsoft Windows®. family of systems (e.g., Windows Server), Linux, Mac™ OS X, Unix, and so on.

Although certain embodiments have been described and illustrated with respect to certain example network topographies and node names and configurations, it should be understood that embodiments are not so limited, and any practical network topography is possible.

Embodiments may be applied to data, storage, industrial networks, and the like, in any scale of physical, virtual or hybrid physical/virtual network, such as a very large-scale wide area network (WAN), metropolitan area network (MAN), or cloud-based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network. The network may comprise any number of server and client computers and storage devices, along with virtual data centers (vCenters) including multiple virtual machines. The network provides connectivity to the various systems, components, and resources, and may be implemented using protocols such as Transmission Control Protocol (TCP) and/or Internet Protocol (IP), well known in the relevant arts. In a distributed network environment, the network may represent a cloud-based network environment in which applications, servers and data are maintained and provided through a centralized cloud-computing platform.

Some embodiments of the invention involve data processing, database management, and/or automated backup/recovery techniques using one or more applications in a distributed system, such as a very large-scale wide area network (WAN), metropolitan area network (MAN), or cloud based network system, however, those skilled in the art will appreciate that embodiments are not limited thereto, and may include smaller-scale networks, such as LANs (local area networks). Thus, aspects of the one or more embodiments described herein may be implemented on one or more computers executing software instructions, and the computers may be networked in a client-server arrangement or similar distributed computer network.

Although embodiments are described and illustrated with respect to certain example implementations, platforms, and applications, it should be noted that embodiments are not so limited, and any appropriate network supporting or executing any application may utilize aspects of the backup management process described herein. Furthermore, network environment 100 may be of any practical scale depending on the number of devices, components, interfaces, etc. as represented by the server/clients and other elements of the network. For example, network environment 100 may include various different resources such as WAN/LAN networks and cloud networks 102 are coupled to other resources through a central network 110.

For the sake of clarity, the processes and methods herein have been illustrated with a specific flow, but it should be understood that other sequences may be possible and that some may be performed in parallel, without departing from the spirit of the invention. Additionally, steps may be subdivided or combined. As disclosed herein, software written in accordance with the present invention may be stored in some form of computer-readable medium, such as memory or CD-ROM, or transmitted over a network, and executed by a processor. More than one computer may be used, such as by using multiple computers in a parallel or load-sharing arrangement or distributing tasks across multiple computers such that, as a whole, they perform the functions of the components identified herein; i.e., they take the place of a single computer. Various functions described above may be performed by a single process or groups of processes, on a single computer or distributed over several computers.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

All references cited herein are intended to be incorporated by reference. While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A method of updating fingerprints for deduplicated data segments in a cluster network utilizing containers to hold directory and files of a filesystem, comprising:
calculating, for each container in the cluster network, new fingerprint hash values using a new hash process that replaces an old hash process that generated current fingerprint hash values for old fingerprints;
first storing the new fingerprint hash values in newly produced containers;
creating a new index mapping from the old hash process to the new hash process, and a new fingerprint index mapping from the new hash process to the containers;
generating, by using the new fingerprint index, new fingerprints with the new hash process;
calculating the new fingerprint hash values of the new fingerprints using the new hash process for storage in the new containers;
second storing all fingerprints of the new fingerprints and the old fingerprints in a container metadata (CMETA) data structure stored in a container comprising segments packed into compression regions;
loading, upon a fingerprint lookup, the CMETA in a memory cache;
checking, upon a fingerprint lookup, the memory cache to determine if a fingerprint is present in the memory cache for an accessed file; and
using the fingerprint if present in the memory cache to speed the fingerprint lookup based upon a stream-informed locality provided by the cached CMETA, otherwise accessing the fingerprint using the new fingerprint index.

2. The method of claim 1 further comprising:
updating relevant data structures using the old fingerprint hash values with the new fingerprint hash values; and
updating content handles to references with the new fingerprints.

3. The method of claim 2 further comprising:
first deleting containers with the data segments fingerprinted with the old hash process;
second deleting a fingerprint index referencing the old hash process;
third deleting the new fingerprint index; and
fourth deleting old data segments fingerprinted with the old hash process.

4. The method of claim 2 wherein the relevant data structures comprise a container metadata section of each container, the new fingerprint index, and a file recipe for the files of the filesystem.

5. The method of claim 4 wherein a fingerprint for each respective data segment is generated using a secure hash (SH) cryptographic hash algorithm, and wherein the fingerprints are stored in a L0 to L6 layered segment tree with the data segments stored in the L0 layer.

6. The method of claim 5 further comprising iterating the calculation of the new fingerprint hash values of the new data segments using the new hash process over each of the L0 to L6 layers.

7. The method of claim 1 wherein the cluster network comprises a Santorini network processing containerized data utilizing a Kubernetes-based framework, and wherein the data comprises deduplicated backup data processed by a deduplicated backup filesystem.

8. A system updating fingerprints for deduplicated data segments in a cluster network utilizing containers to hold directory and files of a filesystem, comprising:
a first calculator calculating, for each container in the cluster network, new fingerprint hash values using a new hash process that replaces an old hash process that generated old fingerprint hash values;
a first system component producing new containers as needed to store the new fingerprint hash values;
a new index mapping component creating a new index mapping from the old hash process to the new hash process, and a new fingerprint index mapping from the new hash process to the containers, and generating, by using the new fingerprint index, new data fingerprints with the new fingerprint hash;
a second calculator calculating the new fingerprint hash values of the new data segments using the new hash process; and
storing all fingerprints of the new fingerprints and the old fingerprints in a container metadata (CMETA) data structure stored in a container comprising segments packed into compression regions;
a memory cache storing, upon a fingerprint lookup, the CMETA;
a second system component checking, upon a fingerprint lookup, the memory cache to determine if a fingerprint is present in the memory cache for an accessed file, using the fingerprint if present in the memory cache to speed the fingerprint lookup based upon a stream-informed locality provided by the cached CMETA, otherwise accessing the fingerprint using the new fingerprint index.

9. The system of claim 8 further comprising an updater updating relevant data structures using the old fingerprint hash values with the new fingerprint hash values, and further updating content handles to references with the new data segments.

10. The system of claim 9 further comprising a cleanup component deleting: containers with the data segments fingerprinted with the old hash process, a fingerprint index referencing the old hash process, the new fingerprint index, and old data segments fingerprinted with the old hash process.

11. The system of claim 8 wherein the relevant data structures comprise a container metadata section of each container, the new fingerprint index, and a file recipe for the files of the filesystem.

12. The system of claim 11 wherein a fingerprint for each respective data segment is generated using a secure hash (SH) cryptographic hash algorithm, and wherein the fingerprints are stored in a L0 to L6 layered segment tree with the data segments stored in the L0 layer.

13. The system of claim 12 further comprising the calculator iterating the calculation of the new fingerprint hash values of the new data segments using the new hash process over each of the L0 to L6 layers.

14. The system of claim 13 wherein the cluster network comprises a Santorini network processing containerized data utilizing a Kubernetes-based framework, and wherein the data comprises deduplicated backup data processed by a deduplicated backup filesystem.

15. A computer program product, comprising a non-transitory computer-readable medium having a computer-readable program code embodied therein, the computer-readable program code adapted to be executed by one or more processors to implement a method of updating fingerprints for deduplicated data segments in a cluster network utilizing containers to hold directory and files of a filesystem, comprising:
calculating, for each container in the cluster network, new fingerprint hash values using a new hash process that replaces an old hash process that generated current fingerprint hash values for old fingerprints;
first storing the new fingerprint hash values in newly produced containers;
creating a new index mapping from the old hash process to the new hash process, and a new fingerprint index mapping from the new hash process to the containers;
generating, by using the new fingerprint index, new fingerprints with the new hash process;
calculating the new fingerprint hash values of the new fingerprints using the new hash process for storage in the new containers;
second storing all fingerprints of the new fingerprints and the old fingerprints in a container metadata (CMETA) data structure stored in a container comprising segments packed into compression regions;
loading, upon a fingerprint lookup, the CMETA in a memory cache;
checking, upon a fingerprint lookup, the memory cache to determine if a fingerprint is present in the memory cache for an accessed file; and
using the fingerprint if present in the memory cache to speed the fingerprint lookup based upon a stream-informed locality provided by the cached CMETA, otherwise accessing the fingerprint using the new fingerprint index.

16. The computer program of claim 15 wherein the method further comprises:
updating relevant data structures using the old fingerprint hash values with the new fingerprint hash values; and
updating content handles to references with the new data segments.

17. The computer program of claim 16 wherein the method further comprises:
first deleting containers with the data segments fingerprinted with the old hash process;
second deleting a fingerprint index referencing the old hash process;
third deleting the new fingerprint index; and
fourth deleting old data segments fingerprinted with the old hash process.

18. The computer program of claim 17 wherein the relevant data structures comprise a container metadata section of each container, the new fingerprint index, and a file recipe for the files of the filesystem.

19. The computer program product of claim 18 wherein a fingerprint for each respective data segment is generated using a secure hash (SH) cryptographic hash algorithm, and wherein the fingerprints are stored in a L0 to L6 layered segment tree with the data segments stored in the L0 layer.

20. The computer program product of claim 19 further comprising iterating the calculation of the new fingerprint hash values of the new data segments using the new hash process over each of the L0 to L6 layers.
